(19) United States
(12) Patent Application Publication
(10) Pub. No.: US 2003/0054215 A1
(43) Pub. Date: Mar. 20, 2003

(54) Compact integrated solid oxide fuel cell system

(75) Inventors: Rajiv Doshi, Torrance, CA (US); Nguyen Minh, Fountain Valley, CA (US); Hal Strumpf, Palos Verdes, CA (US); Joe F. Ferrall, Simi Valley, CA (US)

Correspondence Address: Daniel J Warren, Sutherland Asbill & Brennan LLP, 999 Peachtree Street N E, Atlanta, GA, 30309-3996, US

(73) Assignee: Honeywell International, Inc., Morristown, NJ

(21) Appl. No.: 09/960,086

(22) Filed: Sep. 20, 2001

(51) Int. Cl. H01M 8/10; H01M 8/12; H01M 8/04

(52) U.S. Cl. 429/26; 429/30; 429/34; 429/25; 429/13

(57) ABSTRACT

A compact integrated solid oxide fuel cell power system includes a fuel cell stack, two stages of heat exchange, and a thermal enclosure. The system includes a recuperator which exchanges heat between exhaust gas, heated by oxidizing unspent gases from the fuel cell stack in a combustion chamber, and incoming oxidant to pre-heat the oxidant. The solid oxide fuel cell stack has an internal manifold which exchanges heat between incoming fuel and the preheated oxidant. System components are enclosed by thermal insulation. The system may also include a catalytic partial oxidation reformer to pre-heat the fuel during start up. The system can also include an air compressor, fuel storage tank, and pressure relief valve, providing a portable power system. The air compressor can be used to pressurize the incoming oxidant to the SOFC stack, and to pressurize the fuel storage tank using the pressure relief valve as a pressure regulator.

### BACKGROUND OF THE INVENTION

The present invention generally relates to power systems using solid electrolyte fuel cells and, more particularly, to an efficient compact fuel cell power system.

A fuel cell is a galvanic conversion device that electrochemically reacts a fuel with an oxidant to generate a direct current. A fuel cell typically includes a cathode material, an electrolyte material, and an anode material. The electrolyte is a non-porous material sandwiched between the cathode and anode materials. An individual electrochemical cell usually generates a relatively small voltage. Thus, to achieve higher voltages that are practically useful, the individual electrochemical cells are connected together in series to form a stack. Electrical connection between cells is achieved by the use of electrical interconnects between the cathode and anode of adjacent cells. The electrical interconnects may also provide for passageways which allow oxidant fluid to flow past the cathode and fuel fluid to flow past the anode, while keeping these fluids separated. A dense separator plate between two interconnects keeps the fuel and oxidant flows separated. Alternatively, the passageways may be built into the electrodes of the cell. Also typically included in the stack are ducts or manifolding to conduct the fuel and oxidant into and out of the stack.

The fuel and oxidant fluids are typically gases and are continuously passed through separate passageways. Electrochemical conversion occurs at or near the three-phase boundaries of each electrode (cathode and anode) and the electrolyte. The fuel is electrochemically reacted with the oxidant to produce a DC electrical output. The anode or fuel electrode enhances the rate at which electrochemical reactions occur on the fuel side. The cathode or oxidant electrode functions similarly on the oxidant side.

Fuel cells with solid electrolytes are the most promising technologies for power generation. Solid electrolytes are either ion conducting ceramic or polymer membranes. In the former instance, the electrolyte is typically made of a ceramic, such as dense oxygen-ion conducting yttria-stabilized zirconia (YSZ), that is a nonconductor of electrons, which ensures that the electrons must pass through the external circuit to do useful work. With such an electrolyte, the anode is oftentimes made of nickel/YSZ cermet and the cathode is oftentimes made of doped lanthanum manganite mixed with YSZ.

A number of recent developments have focused on a planar radial flow design for fuel cell stacks. For example, U.S. Pat. No. 4,770,955 discloses an annular shaped anode, cathode, and electrolyte sandwiched therebetween. Annular shaped separator plates sandwich the combination of anode, cathode, and electrolyte. The above components each describe two holes and, consequently, two tubes. One tube provides a fuel flow while the other tube provides an oxidant flow. The cathode is protected from direct fuel contact in one tube by a tubular gasket that forms a seal with one separator and electrolyte. The anode is protected from direct oxidant contact in the other tube by another tubular gasket that forms a seal with the other separator and electrolyte. U.S. Pat. No. 5,589,285 is similar to the foregoing.

Another example of a radial fuel stack design is given by U.S. Pat. No. 4,490,445 which provides alternating circular cells and conductor plates with holes along their peripheries to create fuel and oxidant inlets and outlets. U.S. Pat. No. 4,910,100 discloses various embodiments of a radial fuel cell stack design that include fuel and oxidant channels in the central area of the stack.

More recently, in U.S. Pat. No. 5,549,983, a planar fuel cell stack for solid electrolytes includes an internal manifold having fuel and oxidant cavities. Tubular porous elements surround the manifold for controlling radial fuel and oxidant flows. The tubular porous elements may also be called flow distributor elements or simply flow distributors. Annular, planar cells of anode/electrolyte/cathode are disposed about the porous elements. An annular separator plate is sandwiched between each single cell and each current conductor element. The single cells and separator plates extend at their inner diameters to the inner manifold where a sealant is required to seal the separator plates and single cells to the manifold and porous elements.

When integrating solid electrolyte fuel cell stacks into a complete system for power generation, the use of hydrocarbons as fuel generally requires a larger size system due to the additional equipment required for handling hydrocarbon fuels. In addition, the efficiency of producing power generally decreases with decrease in system size. Thus, the attainment of a compact and portable solid oxide fuel cell (SOFC) power system using hydrocarbon fuels has presented considerable difficulties. For example, U.S. Pat. Nos. 6,194,092 and 5,314,762 disclose compact fuel cell apparatuses, but the apparatuses use hydrogen (H₂) fuel only and are not adaptable for efficient use of hydrocarbon fuel.

U.S. Pat. No. 6,083,636 discloses multiple fuel cell stacks operating at different temperatures, gradually increasing from low to high temperature, using the arrangement of SOFC stacks and flow patterns to reduce air flow requirement and increase efficiency, but is concerned with large power generation systems, for example, using gas turbines, and does not disclose a compact or portable power system. U.S. Pat. No. 6,057,051 discloses a compact system but is specific to metal hydride as fuel source, using a special airflow to heat a hydride to release hydrogen fuel. U.S. Pat. No. 5,952,116 discloses a method for transferring some heat from a solid electrolyte fuel cell stack to incoming reactants, but does not use exhaust heat for efficiently preheating an incoming reactant. U.S. Pat. No. 5,763,114, and similarly U.S. Pat. Nos. 5,612,149; 5,480,738; and 5,366,819, disclose only multiple fuel cell stacks, heat exchanger, and endothermic fuel reformer inside a thermal enclosure but focus on the reformer reaction rather than providing a complete portable system.

As can be seen, there is a need for fuel cell power system with increased efficiency. In particular, there is a need for an efficient fuel cell power system that is compact and portable. Furthermore, there is a need for an efficient compact fuel cell power system using solid oxide fuel cells that is capable of operating on hydrocarbon fuels.

### SUMMARY OF THE INVENTION

The present invention provides an integrated solid oxide fuel cell power system with increased efficiency. Due to the increased efficiency of the integrated fuel cell power system, the present invention provides a compact and also a portable fuel cell power system. Moreover the efficient compact fuel cell power system of the present invention operates on hydrocarbon fuels.

In one aspect of the present invention, an integrated solid oxide fuel cell power system includes a fuel cell stack, two stages of heat exchange, and a thermal enclosure. The solid oxide fuel cell stack has an internal manifold which exchanges heat between the incoming fuel and pre-heated incoming oxidant. For example, a fuel delivery tube can be surrounded in an annular fashion by an oxidant delivery tube with feed tubes disposed in the annular cavity providing fuel flow from the fuel delivery tube to the fuel cells through the oxidant delivery tube while keeping the fuel and oxidant separated. The integrated solid oxide fuel cell power system also includes a recuperator which exchanges heat between an exhaust gas and the incoming oxidant to pre-heat the incoming oxidant, for example, by providing a counterflow of the two gases through adjacent passages. The exhaust gas is heated by combusting depleted gases, containing unspent fuel, from the fuel cell stack in a combustion chamber. The integrated solid oxide fuel cell power system also includes a thermal enclosure. Insulation for the thermal enclosure can be provided by a vacuum vessel, for example, and multi-layer insulation having alternating layers of metal foil and porous ceramic. The integrated solid oxide fuel cell power system may also include a catalytic partial oxidation reformer to pre-heat the fuel for heating the SOFC stack during start up of the power system.

In another aspect of the present invention, the integrated solid oxide fuel cell power system includes an air compressor, a fuel storage tank, and a pressure relief valve to provide a portable compact power system. The air compressor can be used to pressurize the oxidant input to the internal manifold of the SOFC stack. The air compressor can also be used to pressurize the fuel storage tank using the pressure relief valve as a pressure regulator.

These and other features, aspects and advantages of the present invention will become better understood with reference to the following drawings, description and claims.

### BRIEF DESCRIPTION OF THE DRAWINGS

FIG. 1 is a perspective cut-away view of a solid oxide fuel cell compact power system according to an embodiment of the present invention;

FIG. 2 is a diagram, with fuel cell stack and thermally insulated components viewed as a cross section taken along line 2-2 of FIG. 1, of a portion of a solid oxide fuel cell compact power system according to an embodiment of the present invention;

FIG. 3 is a diagram of a side view of a fuel cell stack for a solid oxide fuel cell compact power system according to an embodiment of the present invention;

FIG. 4 is a diagram of a side view of a solid oxide fuel cell stack as previously fabricated;

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides a thermally integrated high-performance, high-power-density solid oxide fuel cell (SOFC) which is integrated into a system providing two-stage heat exchange of incoming air, first, with hot exhaust gases from the SOFC stack and, second, with incoming fuel, and also providing high-performance thermal insulation, rendering the integrated system efficient enough to provide a compact portable power system. It can be operated on JP-8 fuel for military applications, and can also operate on other hydrocarbon fuels, such as the normal-paraffin hydrocarbon hexadecane, C₁₆H₃₄, for example.

In one embodiment, the system incorporates fuel cell stack design for fuel cells that are based on planar, solid electrolytes. Fuel cells with solid electrolytes include polymer electrolyte-based proton exchange membrane (PEM) fuel cells, and SOFC fuel cells. In general, there are two reactant gas streams for fuel cells, a fuel gas stream that flows past the anode electrode and an oxidant gas stream that flows past the cathode electrode. For solid oxide fuel cells, the fuel gas stream may be pure hydrogen, a mixture of hydrogen and carbon monoxide, a mixture of hydrogen and carbon monoxide with inert diluents, a mixture of hydrogen and carbon monoxide with light hydrocarbons and inert diluents, a mixture of hydrogen and carbon monoxide with light hydrocarbons, light alcohols and inert diluents, or direct fuels such as hydrocarbons and alcohols. The oxidant gas stream may be air, air enriched with oxygen, or pure oxygen. Complete integration into a system provides such a significant increase in efficiency over prior art power generation that substantial advantages in size reduction and portability of the present invention are achieved over the prior art.

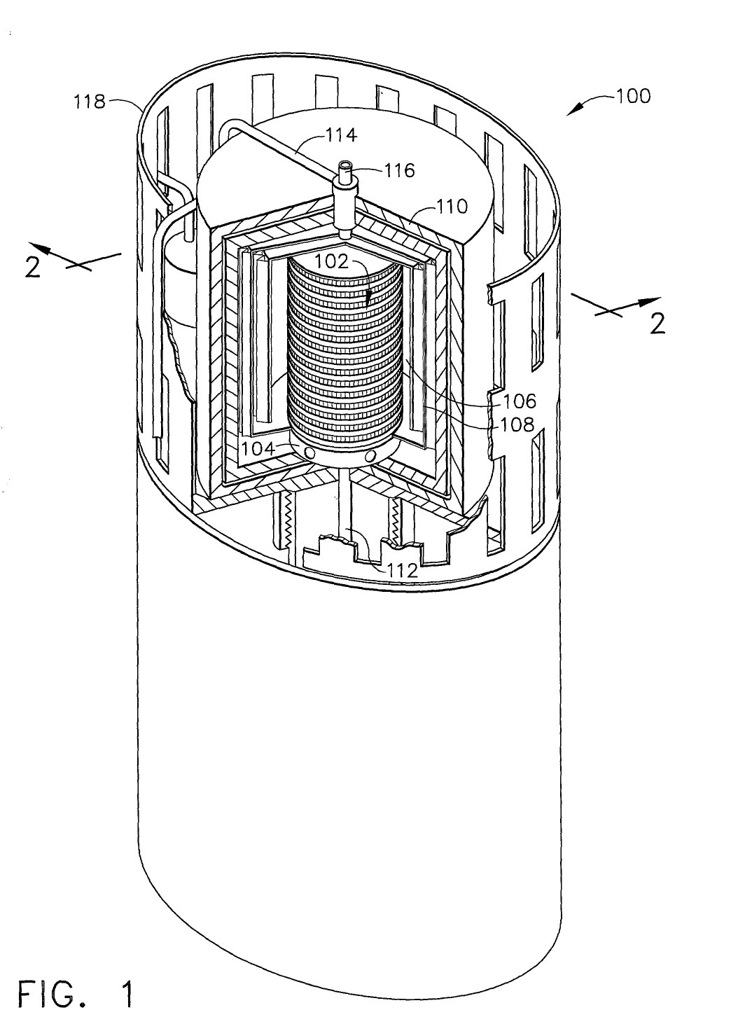

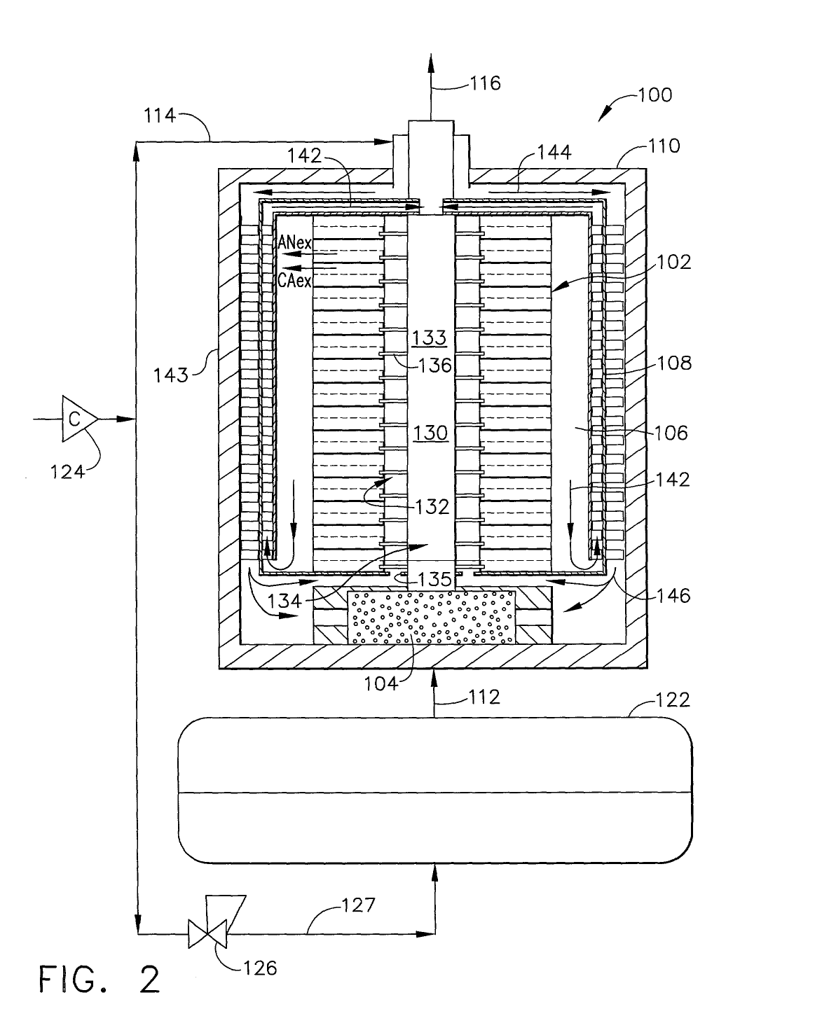

Referring now to FIG. 1, power system 100 is shown according to one embodiment. Included in power system 100 and shown exposed in the cutaway portion of FIG. 1 can be SOFC fuel cell stack 102, fuel vaporizer 104, combustion chamber 106, recuperative heat exchanger or recuperator 108, high-performance thermal enclosure 110, fuel feed 112. FIG. 1 also shows oxidant inlet 114, exhaust 116, and packaging 118 for power system 100. Also included in power system 100 but not shown in FIG. 1 can be a fuel tank, an air compressor or other air flow delivery device, a pressure relief valve, and various other operating components as known in the art, such as wiring, switches, and controllers, for example. Operation and interconnection of these and other components of power system 100 are shown more clearly and in greater detail in FIG. 2.

FIG. 2 shows major components of power system 100 in diagram form, with components enclosed within thermal enclosure 110 viewed as a cross section taken along line 2-2 of FIG. 1. Insulation of thermal enclosure 110 includes a vacuum vessel to minimize surface heat losses. The vacuum vessel may also contain multi-layer insulation formed of alternating layers of metal foils, such as nickel, with porous ceramic.

As seen in FIG. 2, thermal enclosure 110 contains SOFC fuel cell stack 102. Fuel cell stack 102 can be a radial planar design in one embodiment and may include an internal manifold 130 for delivery of fuel and oxidant. The oxidant is air in the present example used to illustrate one embodiment. Internal manifold 130 can include interior cavity 132 for delivery of oxidant to the cathode layers of fuel cell stack 102. Internal manifold 130 may also include interior cavity 134 for delivery of fuel to the anode layers of fuel cell stack 102. The fuel can be a hydrocarbon such as hexadecane, for example. As seen in FIG. 2, interior cavity 132 may be an annular cylinder surrounding interior cavity 134 which has the form of a cylindrical tube. Interior cavity 132 has an opening 135 at the bottom for entry of oxidant air. Feed tubes 136 may pass through interior cavity 132 providing delivery of fuel from interior cavity 134 to the anode layers of fuel cell stack 102, while keeping the fuel and oxidant separated from each other.

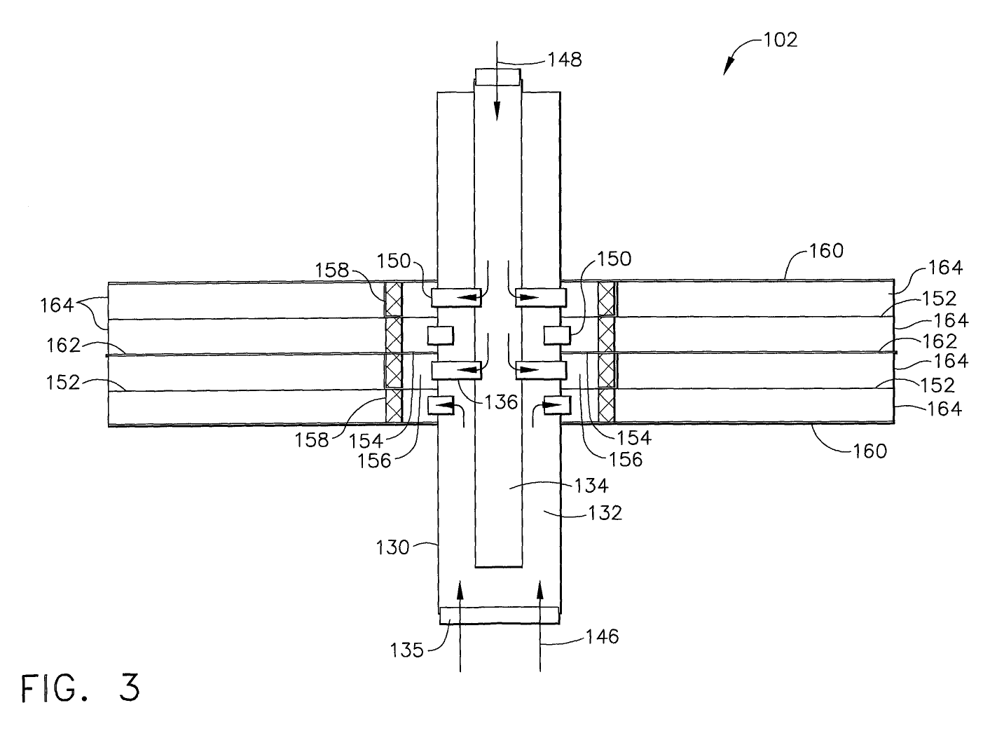

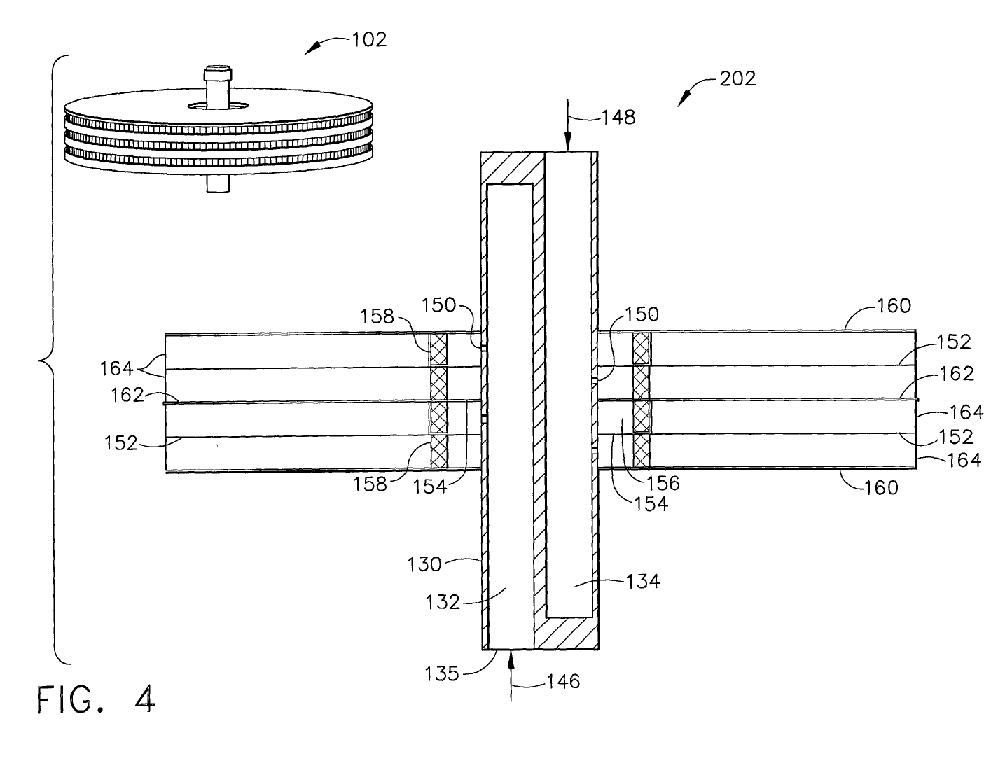

Internal manifold 130 may also include fuel reformer 133 to pre-heat the fuel before it enters fuel cell stack 102. Fuel reformer 133 can be based on a catalytic partial oxidation (CPOX) process which is exothermic. By placing CPOX reformer 133 in the center of the radial SOFC fuel cell stack 102, the heat generated by CPOX fuel reformer 133 may be used, for example, to heat the SOFC stack to operating temperature during start up of power system 100. Fuel reformer 133 can also be used to provide pre-reforming, for example of the JP-8 fuel, to breakdown heavy hydrocarbons to a mixture of mainly lighter hydrocarbons, carbon monoxide, and hydrogen during system operation. Fuel reformer 133 can alternatively provide complete reforming of JP-8 to produce mainly H₂, CO, H₂O, CO₂, and N₂. If the anode is designed to oxidize the hydrocarbon fuel directly, however, there is no CPOX reaction during steady-state, i.e. non-start up, operation,. One possible modification is to incorporate two fuel passages into internal manifold 130 only one of which contains the CPOX catalyst. Other modifications may be apparent to those of ordinary skill in the art. Further details of fuel cell stack 102 and internal manifold 130 are described below in connection with FIGS. 3 and 4.

Continuing with FIG. 2, thermal enclosure 110 may contain fuel vaporizer 104, for vaporizing liquid hydrocarbon fuel, as known in the art. For gaseous hydrocarbon fuels, fuel vaporizer 104 may not be needed and may therefore be left out. Fuel vaporizer 104 is in fluid communication with internal manifold 130 and provides fuel from fuel storage tank 122 in vaporized form to interior cavity 134 of internal manifold 130. If fuel vaporizer 104 is left out, fuel from fuel storage tank 122 may be provided directly to interior cavity 134 of internal manifold 130. Thermal enclosure 110 also contains combustion chamber 106 and recuperator 108. As a practical limit, approximately 90% fuel utilization is achievable in the SOFC stack. The approximately 10% of the fuel which is unreacted or unspent is combusted in combustion chamber 106 forming hot exhaust gas 142. The heat generated by the combustion of unspent fuel in the SOFC stack exhaust is transferred to incoming oxidant in recuperator 108 which provides heat exchange between hot exhaust gas 142 and incoming oxidant or incoming air 144 in the present example used to illustrate one embodiment, to provide pre-heated incoming air 146. Recuperator 108 may be a counter flow heat exchanger, for example, which channels the flow of incoming air 144 and the flow of hot exhaust gas 142 in opposite directions on opposing sides of a separating membrane 143.

FIG. 2 shows other components of power system 100 not enclosed within thermal enclosure 110, including fuel storage tank 122, pressure relief valve 126, fuel pressurization air line 127, air air flow delivery device 124, oxidant inlet 114, and exhaust outlet 116. In one embodiment, air flow delivery device 124 may be, for example, an air compressor, an air pump, or an air blower. Fuel storage tank 122 is provided for fully portable operation of power system 100. Air flow delivery device 124 may preferably be a small efficient air compressor unit for portable operation of power system 100. Pressure relief valve 126 may be used to regulate pressure in fuel pressurization air line 127, so that constant pressurization of fuel storage tank 122 is maintained.

In operation, fuel is delivered under pressure from fuel storage tank 122 via fuel feed 112 into thermal enclosure 110 to fuel vaporizer 104. The fuel is vaporized and enters interior cavity 134 of internal manifold 130. If needed, the fuel may be reformed by CPOX fuel reformer 133 included in internal manifold 130. The fuel passes through feed tubes 136 to the anode layers of fuel cell stack 102 where it provides part of the reactants for power generation. Unspent fuel exits the edge of radial fuel cell stack 102 into combustion chamber 106.

Simultaneously, oxidant, in the present example, air, is pressurized by air flow delivery device 124 and is delivered via oxidant inlet 114 into thermal enclosure 110 as incoming air 144. Incoming air 144 travels through recuperator 108 where it is pre-heated by heat exchange with exhaust gas 142 and exits as pre-heated incoming air 146. Pre-heated incoming air 146 enters interior cavity 132 of internal manifold 130 through opening 135 where it comes in contact with the exterior of interior cavity 134 and feed tubes 136 and is thereby further pre-heated before it is delivered to the cathode layers of fuel cell stack 102 where it provides part of the reaction for power generation. Unspent air exits the edge of radial fuel cell stack 102 into combustion chamber 106. The unspent or unreacted fuel and air in combustion chamber 106 may be combusted to form hot exhaust gas 142. Hot exhaust gas 142 then enters recuperator 108, where it exchanges heat with incoming air 144, and then exits recuperator 108 and thermal enclosure 110 via exhaust outlet 116.

FIG. 3 shows a more detailed diagram of a portion of SOFC fuel cell stack 102 used in one embodiment of power system 100. Fuel cell stack 102 is of a radial planar design and is a circular cylinder in overall configuration, as shown in the left hand portion of FIG. 4. Other shapes for the overall configuration, such as square or cubic, for example, could also be used. Fuel cell stack 102 is generally applicable for the use of solid electrolytes. Accordingly, the present invention contemplates that the fuel cell stack 102 can be used in the context of at least solid oxide fuel cells and proton exchange membrane fuel cells, which are both well known in the art.

Fuel cell stack 102 includes internal manifold 130 that flows preheated incoming air 146 and vaporized incoming fuel 148 into fuel cell stack 102. Although various materials can be used to construct internal manifold 130, preferred materials include ceramics, glass-ceramics, metallic alloys, oxidation resistant metallic alloys, metal-ceramic composites and intermetallics. The preferred external geometrical shape of internal manifold 130 is a right circular cylinder but other shapes could also be used.

Internal manifold 130 may be positioned near the center of fuel cell stack 102. As seen in FIGS. 2 and 3, internal manifold 130 extends from the top of fuel cell stack 102, through fuel cell stack 102, to the bottom of fuel cell stack 102. Formed within internal manifold 130 is interior cavity 132 and interior cavity 134 that extend along the longitudinal length of internal manifold 130. Internal cavity 132 flows oxidant pre-heated incoming air 146, and interior cavity 134 flows vaporized incoming fuel 148 into internal manifold 130.

As seen in FIG. 3, internal manifold 130 describes a plurality of openings, which are flow orifices 150. Flow orifices 150 provide a means for pre-heated incoming air 146 and incoming fuel 148 to flow out of interior cavities 132 and 134. Flow orifices 150 allow pre-heated incoming air 146 to flow out of interior cavity 132 and incoming fuel 148 to flow out of interior cavity 134. Flow orifices 150 are properly sized to enable the uniform distribution of pre-heated incoming air 146 to each and every cell 152 in fuel cell stack 102. Similarly, flow orifices 150 are also properly sized to enable the uniform distribution of incoming fuel 148 to each and every cell 152 in fuel cell stack 102.

A plurality of annular manifold brackets 154 are fixed about the exterior of internal manifold 130. Preferably, brackets 154 are brazed to internal manifold 130, but other means can be used. In FIG. 3, immediately adjacent brackets 154 form between them channels 156, also denoted “annular void space”, that lead from flow orifices 150 in internal manifold 130. Brackets 154 are each cylindrically shaped (minus one end) in one embodiment. However, other configurations and orientations may be useful and each of the brackets 154 need not be of the same configuration and orientation. Brackets 154 are preferably made of the same material or closely similar material as that used for internal manifold 130 in order to eliminate the possibility of galvanic corrosion and potentially damaging thermal stresses arising from mismatch of thermal expansion coefficients. If internal manifold 130 and manifold brackets 154 are made of electrically conducting materials, manifold brackets 154 preferably have an electrically insulating layer, or coating, on their exterior surfaces.

A flow distributor 158, which is annular and porous, is positioned between each pair of adjoining manifold brackets 154 and within the channels 156. The porous flow distributors 158 serve to uniformly distribute pre-heated incoming air 146 or incoming fuel 148 to cells 152 substantially uniformly over 360° and can be made of materials such as metallic alloys, intermetallics, metal-ceramic composites, ceramics, and glass-ceramics.

Each of the manifold brackets 154 may be sealed at the outer periphery (such as by a sealant made of glass or glass-ceramics, in one embodiment a seal bracket (not shown) may be used) to an inner periphery of either an end plate 160, a single cell 152, or a separator plate 162, all of which are described below.

The end or current collector plate 160, single cell 152, and separator plate 162 are constructed and serve functions according to that well known in the art. For the embodiment shown in FIG. 3, an end plate 160 may be disposed at the top and bottom of fuel cell stack 102. End plates 160 sandwich between them a sequence (starting from top to bottom) of an interconnect 164, single cell 152, interconnect 164, separator plate 162, interconnect 164, single cell 152, and interconnect 164. However, it should be understood that the foregoing sequence can be extended to incorporate additional single cells 152, or even be shortened to delete a single cell 152. In such event, the number of interconnects 164 and separator plates 162 will accordingly change.

Both end plates 160, which are annular and planar, serve to collect current generated by single cells 152 and can be constructed of electrically conducting materials such as metals, oxidation resistant alloys, stainless steel, or superalloys.

The interconnects or current conductor elements 164 may also be annular in configuration and fixed to their immediately adjacent components of end plates 160 or separator plates 162 by such means as brazing or bonding. The interconnects 164 preferably may be made of an electronic conductor element for carrying current from one single cell 152 to the separator or end plate. Suitable materials for the interconnects 164 include metallic alloys, intermetallics, metal-ceramic composites, and electron conducting ceramics. Interconnects 164 preferably may have a skeletal structure so that they allow unimpeded flow of pre-heated incoming air 146 and incoming fuel 148. The material comprising interconnects 164 should be distributed uniformly in all directions in the space between each single cell 152 and separator plate 162 (or end plate 160) so as to facilitate the radial flow of incoming fuel 148 and preheated incoming air 146.

The outer peripheries of interconnects 164 may extend substantially to the outer peripheries of end plates 160 (or separator plates 162). The inner peripheries of interconnects 164 may extend substantially to flow distributors 158. One set of interconnects 164 may be in flow communication with oxidant pre-heated incoming air 146. Another set of interconnects 164 may be in flow communication with fuel 148. This enables interconnects 164 to channel preheated incoming air 146 across a cathode side of single cells 152 and incoming fuel 148 across an anode side of single cells 152.

The interconnects 164 and separator plates 162 may be made of metal foils, i.e., thin metal sheets, so as to lead to lightweight stacks. Yet, these components need to have sufficient thickness to provide the desired lifetime for fuel cell stack 102. The metal foils may be formed into a variety of geometrical shapes which provide for uniform fluid flow in the radial direction and sufficient electrical current conduction capacity in the longitudinal direction. One example of an interconnect 164 structure may be thin metal foils formed into offset fin shapes and sliced and arranged so as to facilitate the radial flow direction of the oxidant air and fuel gases 144, 148. Another example of an interconnect 164 structure may be thin metal plates of very high porosity, i.e., porosity in excess of 90% by volume, such as nickel foam which can be used as the interconnect 164 on the anode side of cell 152.

The materials used for internal manifold 130, manifold bracket 154, flow distributor 158, end plates 160, separator plates 162 and interconnects 164 should be selected so as to have thermal expansion behavior similar to the material of cell 152, so that thermal stresses do not develop during thermal cycling from ambient temperature to the operating temperature and back. In the case of interconnects 164, some thermal expansion mismatch can be accommodated by incorporating compliance aspects in this part either by geometrical design or by proper selection of the material. Nickel foam, for example, is inherently a compliant material and its thermal expansion mismatch with cell 152 does not lead to damaging thermal stresses.

As mentioned above, single cells 152 have an anode side and a cathode side. These two sides are provided by the well known tri-layer construction of anode-electrolyte-cathode. The anode layer in cell 152 may be made of nickel/YSZ cermet; the electrolyte layer can be made of yttria-stabilized zirconia (YSZ); and the cathode layer may be made of strontium-doped lanthanum manganite.

Separator plate 162 that is disposed between two interconnects 164 is annular and planar in configuration in the embodiment shown in FIG. 3. Separator plate 162 serves to separate the flows of pre-heated incoming air 146 and fuel 148 as they pass through the interconnects 164. Separator plate 162 must be made of an electronic conductor material to also carry the current generated from one single cell 152 to the next. Thus, separator plate 162 may be made from metallic alloys, intermetallics, metal-ceramic composites, and electronic conducting ceramics.

During operation of the fuel cell stack 102, pre-heated incoming air 146 flows into interior cavity 132 of internal manifold 130 while fuel 148 flows into interior cavity 134. Pre-heated incoming air 146 flows out of interior cavity 132 through flow orifices 150, into annular void spaces or channels 156, and out through flow distributors 158. Likewise, fuel 148 flows out of interior cavity 134 through flow orifices 150, into annular void spaces or channels 156, and out through flow distributors 158. Pre-heated incoming air 146 then moves through one set of interconnects 164 and across the cathode side of single cells 152 in a substantially uniform radial flow. Fuel 148 moves through another set of interconnects 164 and across the anode side of single cells 152 also in a substantially uniform radial flow. The electrochemical reactions produced by cells 152 produce a current that is carried through fuel cell stack 102 to an end plate 160. Spent, or depleted, fuel and oxidant is exhausted out of the sides of fuel cell stack 102 into combustion chamber 106.

No sealing is required on the edges of fuel cell stack 102. For better control of the electrochemical performance of the stack, however, it may be advantageous to install a so-called gas barrier ring at the periphery of the interconnects 164 on the anode and cathode sides of cells 152. The gas barrier ring impedes backflow of gases into the interconnect 164 spaces. In particular, a gas barrier ring at the periphery of interconnect 164 would impede backflow or diffusional flow of oxidant gas into the interconnect space, which would locally change the concentration of the fuel and affect the electrochemical performance of the stack. The barrier ring may be made of ceramic, metallic, ceramic-metallic composites, or ceramic fiber.

FIG. 4 shows an alternative embodiment of a portion of SOFC fuel cell stack 202 in a diagram similar to that of FIG. 3. Fuel cell stack 202, shown in FIG. 4, includes substantially the same components, having similar functions and numbered similarly, as those of fuel cell stack 102, shown in FIG. 3. For example, fuel cell stack 202 includes internal manifold 130, with interior cavities 132 and 134, opening 135, and flow orifices 150. As seen in FIG. 4, the configuration of internal manifold 130 of fuel cell stack 202 is simpler, not requiring fuel feed tubes 136, but is less efficient as a heat exchanger between incoming fuel 148 and oxidant pre-heated incoming air 146.

An improved radial flow fuel cell stack similar to the one shown and described in FIG. 4 is disclosed in U.S. patent application entitled “Radial Planar Fuel Cell Stack Construction For Solid Electrolytes”, Ser. No. 09/427,436 filed on Oct. 26, 1999, and assigned to the assignee of the present invention. The disclosure in that patent application is hereby fully incorporated by reference into the present application.

The overall system efficiency, defined as the useful power produced divided by the lower heating value of the fuel is estimated at approximately 51% with a low loss insulation system such as a multi-layer insulation in a vacuum vessel.

It should be understood, of course, that the foregoing relates to preferred embodiments of the invention and that modifications may be made without departing from the spirit and scope of the invention as set forth in the following claims.

We claim:

1. A fuel cell power system comprising:
a fuel cell stack having a manifold wherein heat is exchanged between a fuel fluid and an oxidant fluid;
a recuperator wherein heat is exchanged between an exhaust gas from said fuel cell stack and said oxidant fluid;
a thermal enclosure surrounding said fuel cell stack, said manifold, and said recuperator.

2. The fuel cell power system of claim 1, further comprising a combustion chamber inside said thermal enclosure for oxidizing said exhaust gas.

3. The fuel cell power system of claim 1, further comprising a reformer inside said thermal enclosure wherein fuel is pre-heated before delivery to said fuel cell stack.

4. The fuel cell power system of claim 3, wherein said reformer uses catalytic partial oxidation to pre-heat said fuel.

5. The fuel cell power system of claim 1, further comprising a fuel vaporizer inside said thermal enclosure, said fuel vaporizer in fluid communication with said manifold .

6. The fuel cell power system of claim 5, further comprising:
a fuel storage tank in fluid communication with said fuel vaporizer;
a pressure relief valve; and
an air flow delivery device wherein said air flow delivery device pressurizes said oxidant fluid and delivers said oxidant fluid to said manifold and wherein said air flow delivery device provides pressurization for said fuel storage tank, and said pressure relief valve regulates said pressurization.

7. The fuel cell power system of claim 1, wherein said thermal enclosure includes a vacuum vessel.

8. The fuel cell power system of claim 1, wherein said thermal enclosure includes multi-layer insulation comprising alternating layers of metal foil and porous ceramic.

9. The fuel cell power system of claim 1, wherein said manifold is an internal manifold.

10. The fuel cell power system of claim 1, wherein said air flow delivery device is an air compressor.

11. A fuel cell stack, comprising:
an internal manifold having a first interior cavity, a second interior cavity, a first flow orifice and a second flow orifice wherein a first fluid is delivered through said first flow orifice, a second fluid is delivered through said second flow orifice, heat is exchanged between said first and second fluids, and said first and second fluids are kept separate;
a fuel cell having an anode layer, a cathode layer, and an electrolyte layer between said anode layer and said cathode layer, said fuel cell being disposed about said internal manifold; and
at least one separator plate disposed about said internal manifold and defining a first channel and second channel, said first channel providing fluid communication between said first flow orifice and said anode layer, said second channel providing fluid communication between said second flow orifice and said cathode layer.

12. The fuel cell stack of claim 11, wherein said second interior cavity is annularly disposed about said first interior cavity and a feed tube disposed within said second interior cavity provides fluid communication between said first interior cavity and said first flow orifice.

13. The fuel cell stack of claim 11, further comprising a porous flow distributor disposed in said first channel.

14. The fuel cell stack of claim 11, further comprising a porous flow distributor disposed in said second channel.

15. The fuel cell stack of claim 11, further comprising an interconnect disposed between said separator plate and said anode layer.

16. The fuel cell stack of claim 11, further comprising an interconnect disposed between said separator plate and said cathode layer.

17. The fuel cell stack of claim 11, further comprising a pair of end plates disposed on opposite sides of said cell.

18. The fuel cell stack of claim 11, wherein said single cells comprise solid oxide fuel cells.

19. The fuel cell stack of claim 11, wherein said single cells comprise proton exchange membrane fuel cells.

20. The fuel cell stack of claim 11, wherein said single cells have a substantially planar and annular configuration.

21. The fuel cell stack of claim 11, wherein said first interior cavity receives a fuel and said second interior cavity receives an oxidant.

22. The fuel cell stack of claim 15, wherein said interconnect is made of metal foil in an off-set fin structure.

23. The fuel cell stack of claim 16, wherein said interconnect is made of metal foil in an off-set fin structure.

24. The fuel cell stack of claim 15, wherein said interconnect is made of a porous metal.

25. The fuel cell stack of claim 16, wherein said interconnect is made of a porous metal.

26. The fuel cell stack of claim 15, wherein said interconnect for an anode side of said cells is made of nickel foam.

27. A fuel cell power system comprising:
a fuel cell stack having a manifold wherein heat is exchanged between a fuel fluid and an oxidant fluid;
said manifold including a catalytic partial oxidation fuel reformer;
a fuel vaporizer in fluid communication with said manifold;
a combustion chamber wherein an exhaust gas from said fuel cell stack is oxidized;
a recuperator wherein heat is exchanged between said exhaust gas and said oxidant fluid;
a thermal enclosure enclosing said fuel vaporizer, said fuel cell stack, said manifold, said catalytic partial oxidation fuel reformer, said combustion chamber, and said recuperator;
a fuel storage tank in fluid communication with said fuel vaporizer;
a pressure relief valve;
an air flow delivery device wherein said air flow delivery device pressurizes said oxidant fluid and delivers said oxidant fluid to said manifold and wherein said air flow delivery device provides pressurization for said fuel storage tank, and said pressure relief valve regulates said pressurization.

28. A method of power generation comprising steps of:
using a fuel cell stack to generate power;
combusting an exhaust gas from said fuel cell stack;
exchanging a first heat between said exhaust gas and an oxidant fluid;
exchanging a second heat between a fuel fluid and said oxidant fluid;
enclosing said fuel cell stack, said first heat, and said second heat within a thermal enclosure.

29. The method of claim 28, further comprising a step of vaporizing said fuel fluid.

30. The method of claim 28, further comprising a step of reforming said fuel fluid.

31. The method of claim 30, wherein said reforming step includes a catalytic partial oxidation process.

32. The method of claim 28, further comprising a step of providing said fuel fluid from a fuel storage tank to said fuel cell stack.

33. The method of claim 28, further comprising a step of pressurizing said oxidant fluid.

34. The method of claim 32, further comprising a step of pressurizing said fuel storage tank.

35. The method of claim 33, wherein said step of pressurizing said fuel storage tank is regulated using a pressure relief valve.

36. The method of claim 28 wherein said enclosing step uses a vacuum vessel.

37. The method of claim 28 wherein said enclosing step uses multi-layer insulation comprising alternating layers of metal foil and porous ceramic.
